(19) United States
(12) Patent Application Publication
(10) Pub. No.: US 2004/0240060 A1
(43) Pub. Date: Dec. 2, 2004

(54) Terahertz time-domain differentiator

(76) Inventors: Roland I Kersting, Albany, NY (US); Aleksey I Filin, Rensselaer, NY (US); Matthew C Stowe, Pasadena, CA (US)

Correspondence Address: Kevin R Casey, RatnerPrestia, Suite 301, One Westlakes, Berwyn, P O Box 980, Valley Forge, PA, 19482-0980, US

(21) Appl. No.: 10/487,204

(22) PCT Filed: Jun. 26, 2002
(86) PCT No.: PCT/US02/20255

Related U.S. Application Data
(60) Provisional application No. 60/314,920, filed on Aug. 27, 2001.

(51) Int. Cl. G02B 5/18; G02B 27/42

(52) U.S. Cl. 359/558

(57) ABSTRACT

A device and method for differentiating an incident electromagnetic pulse. A conductive grating is provided with a sub-wavelength period, an area larger than the electromagnetic beam diameter, and a grating conductor thickness greater than the skin depth of the electromagnetic pulse. The grating conductors are oriented essentially parallel to the incident electromagnetic pulse to diffract the electromagnetic pulse. An aperture captures only the zero order diffraction of the electromagnetic pulse, which is the first time-derivative of the incident electromagnetic pulse.

### TECHNICAL FIELD

The present invention is directed generally to a device and method for performing time-domain differentiation of electromagnetic waves and, more particularly, to a device and method for performing time-domain differentiation of electromagnetic pulses in the terahertz frequency range.

### BACKGROUND OF THE INVENTION

The time derivative of an electromagnetic pulse can be obtained using an analog differentiator with an operational amplifier. These analog differentiators are described, for example, by B. Vassos and G. Ewing in “Analog and Computer Electronics for Scientists” (John Wiley and Sons, Inc., 4^{th} ed. 1993). Such differentiators use macroscopic electrical currents and displacement currents.

The bandwidth of analog differentiators using operational amplifiers is limited by the resistance, capacitance, and inductance of the electronic devices used. The bandwidth of the operational amplifier also limits the bandwidth of the analog differentiator. Even integrated resistors, capacitors, and inductors would limit the bandwidth of an analog differentiator using such electronic components to a bandwidth having frequencies in the range of tens of gigahertz.

Diffraction gratings are used in various signal processing applications. For example, U.S. Pat. No. 5,101,297 issued to Yoshida et al. is directed to a method for producing a diffraction grating in optical elements. FIGS. 1a and 1b show an optical wavelength conversion element in which a striped optical wave guide is formed in the middle portion of a substrate comprising a non-linear optical material. Using a sintered target consisting of In₂O₅ mixed with 10% SnO₂, an indium tin oxide (ITO) film is deposited to a thickness of about 0.1 micrometers as a transparent conductive film on a substrate including the optical wave guide. Polymethyl methacrylate (PMMA) film is formed and cured on the ITO film as an electron beam resist film. A diffraction pattern is drawn on the PMMA film with an electron beam, and the PMMA film is developed to form the diffraction grating. Yoshida et al. suggest using the disclosed diffraction grating for optical coupling. In another example, U.S. Pat. No. 6,031,243 issued to Taylor is directed to a vertical cavity opto-electronic device using a blazed grating to couple electromagnetic waves.

In U.S. Pat. No. 5,953,161 issued to Troxell et al., a diffraction grating array is used in an infra-red (IR) imaging system. The diffraction grating is used in an active state to diffract IR radiation of the pre-determined IR wavelength at a pre-determined angle to strike an IR detector. In an inactive state, the diffraction grating does not diffract IR radiation of the pre-determined wavelength at the pre-determined angle. The diffraction grating has a plurality of parallel bars of constant width, the width of each bar being on the order of one-half the pitch between adjacent bars. Each bar is suspended over and parallel to a substrate. The bars are provided with an optically reflective and electrically conductive coating, with a similar coating on the substrate below the bars. The diffraction grating is switched to an active state by applying a voltage potential to deform the bars.

A published article by A. Churpin et al., “Phase Characteristics of Thick Metal Grating,” Proc. Microwave Antennas Propog. 145, 411 (1998), is directed to setting the periodicity (<<λ) of a thick metal grating to provide frequency and incident angle independence for reflected and transmitted coefficient phases of E-polarized transmissions at frequencies <20 GHz. The article suggests that such gratings may be useful in building polarization rotators and power dividers. Disclosed is a ninety-degree phase shift for transmitted waves when the reference plane coincides with the symmetry plane of the grating conductors.

Another published article by J. White et al., “Response of Grating Pairs to Single-Cycle Electromagnetic Pulses,” J. Opt. Soc. Am., Vol. 12, No. 9, p. 1687 (September 1995), is directed to time-domain pulse shaping with diffraction gratings and presents experimental time-resolved data for various gratings. Yet another published article by K. Wynne and D. Jaroszynski, “Superliminal Terahertz Pulses,” Optics Letters, Vol. 24, No. 1 (January 1999), is directed to time-resolved experiments of terahertz pulses transmitted through a silicon-on-sapphire chip, showing superluminal transport.

Although analog time domain differentiators using operational amplifiers are known, a need exists for a time-domain differentiator that can operate in the terahertz frequency range, and that can provide an adequate operational bandwidth.

### SUMMARY OF THE INVENTION

To meet these and other needs, and in view of its purposes, an exemplary embodiment of the present invention provides a device and method for differentiating an incident electromagnetic pulse. A conductive grating is provided with a sub-wavelength period, an area larger than the electromagnetic beam diameter, and a grating conductor thickness greater than the skin depth of the electromagnetic pulse. The grating conductors are oriented essentially parallel to the incident electromagnetic pulse to diffract the electromagnetic pulse. An aperture captures only the zero order diffraction of the electromagnetic pulse which is the first time derivative of the incident electromagnetic pulse.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a diffraction grating according to an exemplary embodiment of the invention;

FIG. 2 is a sectional view of the diffraction grating of FIG. 1 taken generally along the line 2-2;

FIG. 3 shows an incident electromagnetic signal being diffracted by a diffraction grating according to an exemplary embodiment of the invention;

FIG. 4 shows a time-domain differentiator according to an exemplary embodiment of the invention; and

FIG. 5 shows measurement data for a pulse incident the time-domain differentiator of FIG. 4, the output pulse from the time-domain differentiator, and the calculated derivative of the incident pulse.

### DETAILED DESCRIPTION OF THE INVENTION

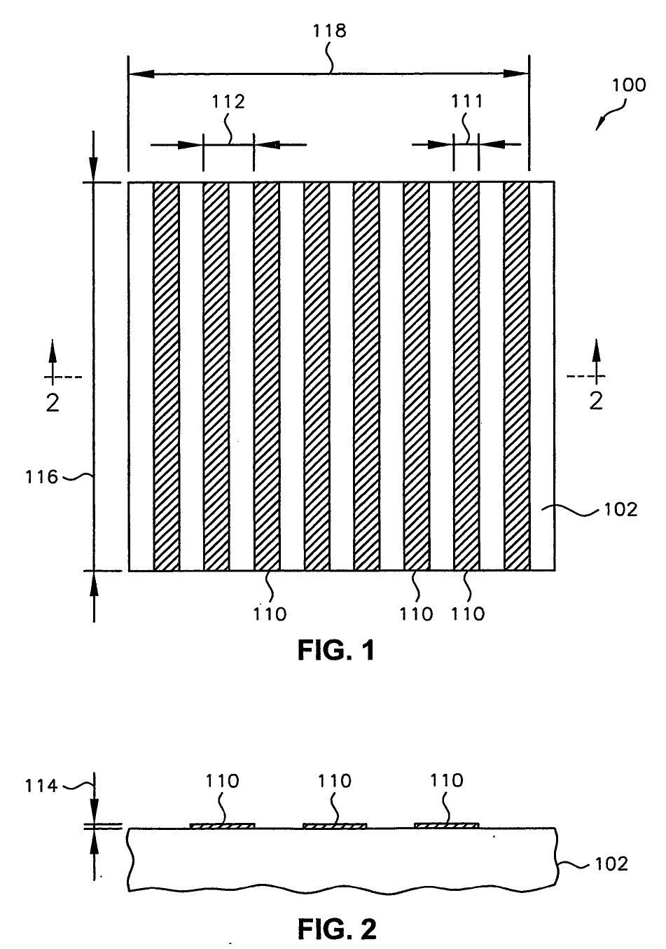

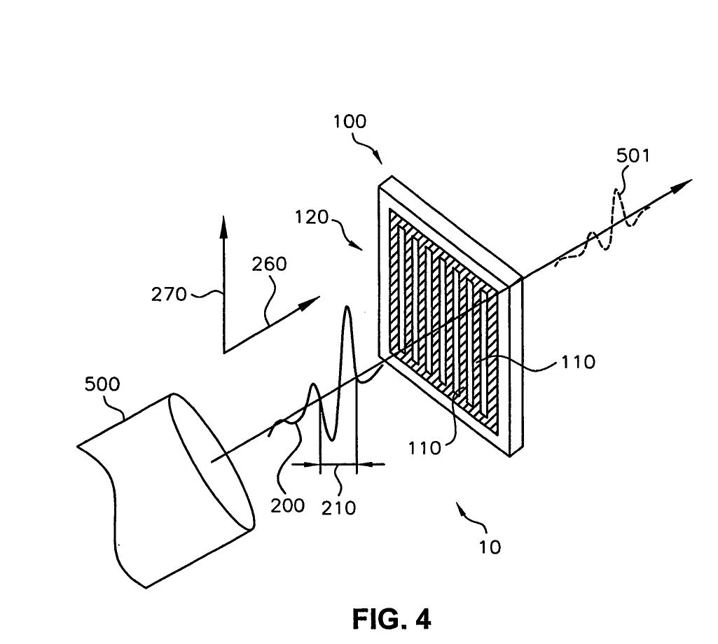

Referring now to the drawing, in which like reference numbers refer to like elements throughout, FIGS. 1 and 2 show a diffraction grating 100 for use in a time-domain differentiator according to an exemplary embodiment of the present invention. Grating 100 comprises a plurality of parallel conductors 110, formed on an optically transparent substrate 102. Conductors 110 are sized to correspond to physical parameters of an incident input signal 200 (shown in FIG. 4) and, more particularly, to the wavelength (λ) 210.

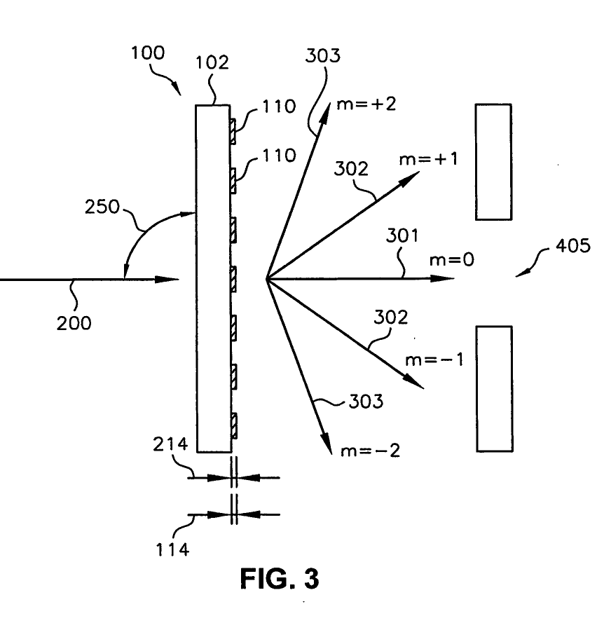

Conductors 110 each have a width 111 and period 112 (the distance from the beginning of one conductor to the beginning of the next conductor). Width 111 is about one-half of period 112, and period 112 is less than the wavelength 210 of incident input signal 200. Conductors 110 have a thickness 114 greater than the skin depth 214 (shown in FIG. 3) of incident input signal 200 in the conductors. Skin depth 214 of incident input signal 200 in conductors 110 is the depth that incident input signal 200 will penetrate into conductors 110, and is determined by the frequency of incident input signal 200 and the material comprising conductors 110. Thickness 114 is greater than skin depth 214 so that incident input signal 200 is diffracted by, and does not penetrate, conductors 110.

Conductors 110 may comprise any of a variety of conductive materials, including, but not limited to, gold (Au). Grating 100 may be formed, for example, by selective metal deposition or by patterning a blanket deposition layer such as with e-beam evaporation. Substrate 102 may be, for example, a silicon wafer or Mylar® foil. Conductors 110 (and grating 100) have a length 116 which is greater than wavelength 210. Grating 100 has a width 118 equal to period 112 multiplied by the number of conductors 110. Diffraction grating 100 has an area equal to length 116 multiplied by width 118. The area is sufficient to cover incident input signal 200.

In an exemplary embodiment of the invention, as shown in FIG. 3, diffraction grating 100 is disposed to diffract incident input signal 200 (i.e., an electromagnetic wave). Conductors 110 are oriented essentially parallel to incident input signal 200. Incident input signal 200 enters diffraction grating 100 at an incident angle 250 of about ninety (90) degrees to width 118 of diffraction grating 100. Incident input signal 200 is diffracted by diffraction grating 100 into zero order diffraction signal 301, first order diffraction signals 302, second order diffraction signals 303, and lower order diffraction signals (not shown). An aperture 405 is disposed to transmit only zero order diffraction signal 301, which is the time-domain derivative of incident input signal 200, as an output signal.

The present invention provides time-domain differentiation of an input signal provided as an optical electromagnetic wave instead of an electrical current as in existing differentiators. Differentiation of optical waves provides differentiation of signals have frequencies in the terahertz range. Such frequencies facilitate modern high-speed signal processing applications.

In an exemplary embodiment of the invention, incident input signal 200 has a center frequency with frequency variation. Wavelength 210 is the inverse of the center frequency. Period 112 of diffraction grating 100 is less than wavelength 210 divided by the product of two and the natural log of two. In this exemplary embodiment, diffraction grating 100 provides a spectral operational frequency range of between about 0.3 and 1.5 times the center frequency. This spectral range is significantly greater than the spectral range for electronic current differentiators.

Referring now to FIG. 4, a domains differentiator 10 is provided. Time-domain differentiator 10 comprises grating 100 having a grating face 120 with an area greater than the beam diameter of the electromagnetic pulse (incident input signal 200) to be differentiated. The beam diameter is the area covered by the pulse perpendicular to the direction of propagation 260 of incident input signal 200. Grating 100 is disposed to receive the pulse incident grating face 120 and to diffract the pulse.

A signal source 500 provides incident input signal 200 (i.e., an electromagnetic wave) to grating 100. Incident input signal 200 has a wavelength 210, a skin depth 214 in conductors 110 of grating 100, and a beam diameter (not shown). Incident input signal 200 is polarized by, for example, an electric field 270 generally perpendicular to direction of propagation 260 and parallel with conductors 110. Electric field 270 orients incident input signal 200 generally along length 116 (shown in FIG. 1) of conductors 110.

Output terahertz pulse 501 (based on zero order diffraction) propagates from diffraction grating 100 opposite grating face 120 in direction of propagation 260. Aperture 405 (shown in FIG. 3) captures only output pulse 501 which may be transmitted through a fiber optic cable, waveguide, or the like. Output pulse 501 is the time domain derivative of incident input signal 200. Output pulse 501 (i.e., time-domain derivative) may be useful in a variety of signal-processing applications, including but not limited to: precise triggering of ultrafast signals due to its very sharp signal peaks, markers for use in jitter reduction algorithms, precision clock signals, and exchange of real and imaginary portions of dielectric response function for use in spectroscopy.

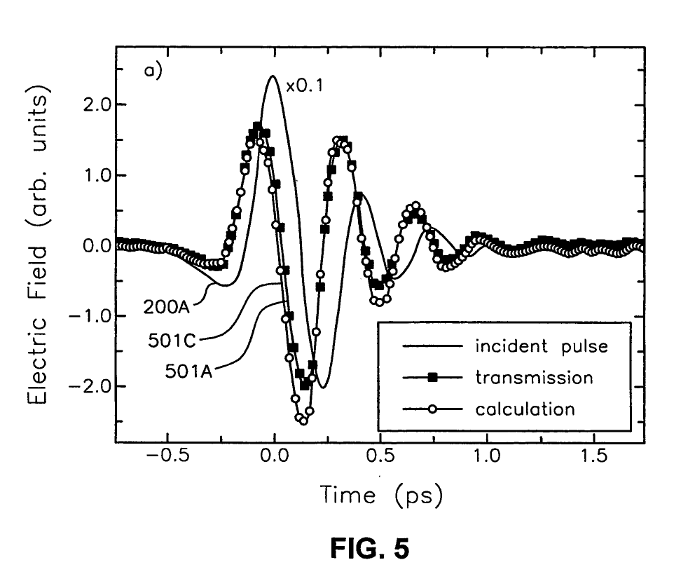

Referring now to FIG. 5, an incident input pulse 200A having a frequency of about 2 terahertz was provided to various time-domain differentiators 100A as described above. Time-domain differentiators 10A comprise a 10 mm by 10 mm gold grating 100A having a period of from 10 to 40 micrometers and a filling factor of about 50% (i.e., conductor width 111A is one-half of period 112A). Thickness 114A is about 200 nm which is substantially greater than the skin depth in gold at 1 THz (approximately 30 nm). Incident input pulse 200A is generated by excitation of an n-doped InAs crystal with 70 fs laser pulses of 770 nm wavelength and 5 nJ pulse energy. The center frequency of input pulse 200A is about 2.25 THz, which corresponds to a wavelength of about 130 micrometers. An aperture 405A captures only the zero order diffraction 301A from grating 100A. Incident input pulse 200A and output pulse 501A were measured using terahertz time-domain spectroscopy (THz-TDS) and theoretical output signal 501C was calculated. As shown in FIG. 5, measured output pulse 501A from time domain differentiator 10A shows very good correlation with theoretical output signal 501C which is the time-domain derivative of incident input pulse 200A.

In an exemplary embodiment of the invention, a method is provided for performing a time-domain differentiation of an electromagnetic pulse. An electromagnetic pulse (or range of pulses) that is to be differentiated is identified. For example, a wavelength, a center frequency, a skin depth in a conductor, and a beam diameter for the pulse is determined. A diffraction grating is provided comprising spaced parallel conductive lines composed of the conductor and having a period less than the wavelength, a thickness greater than the skin depth, an area greater than the beam diameter, and a length greater than the wavelength. The diffraction grating is oriented such that the electromagnetic pulse is incident to the diffraction grating and aligned with the conductive lines. Only the zero order diffraction of the incident electromagnetic pulse is captured, which is the time-domain derivative of the input pulse.

Although illustrated and described above with reference to certain specific embodiments, the present invention is nevertheless not intended to be limited to the details shown. Rather, various modifications may be made in the details within the scope and range of equivalents of the claims and without departing from the invention.

What is claimed:

1. A grating for diffraction of an incident electromagnetic wave, the grating comprising parallel conductors disposed on an optically transparent substrate to diffract the incident electromagnetic wave such that a zero order diffraction of the electromagnetic wave is the tine domain derivative of the incident electromagnetic wave when the conductors are oriented essentially parallel to the incident electromagnetic wave the electromagnetic wave having a wavelength and a skin depth in the conductors, the conductors having a period less than the wavelength, a thickness greater than the skin depth, and a length greater than the wavelength.

2. The grating of claim 1 wherein the electromagnetic wave has a frequency of greater than one terahertz.

3. The grating of claim 1 wherein the conductors comprise a pattern of metal lines formed on a transparent substrate.

4. The grating of claim 1 wherein the time domain derivative is provided without using an electrical current.

5. The grating of claim 1 wherein the period is less than the wavelength divided by the product of two and the natural log of two.

6. The grating of claim 5 wherein the incident electromagnetic wave comprises pulses having a center frequency corresponding to the wavelength, and the grating provides a spectral operational frequency range of between about 0.3 and 1.5 times the center frequency.

7. A time-domain differentiator comprising:
a signal source providing a polarized input electromagnetic wave having a wavelength a skin depth, and a beam diameter;
a grating having a grating face wit an area greater than the beam diameter and disposed to receive the polarized input electromagnetic wave incident the grating face and diffract the polarized input electromagnetic wave, providing a zero order diffraction, the grating face comprising parallel conductors having a period less than the wavelength and a thickness greater than the skin depth, the conductors being formed on an optically transparent substrate and oriented essentially parallel to the polarized input electromagnetic wave; and
an aperture sized and positioned to capture only the zero order diffraction of the diffracted polarized input electromagnetic wave, the zero order diffraction being an electromagnetic wave essentially equivalent to the time-domain derivative of the polarized input electromagnetic wave.

8. The time-domain differentiator of claim 7 wherein the electromagnetic wave has a frequency of greater than one terahertz.

9. The time-domain differentiator of claim 7 wherein the conductors comprise a pattern of metal lines formed on a transparent substrate,

10. The time-domain differentiator of claim 7 wherein the time-domain derivative is provided without using an electrical current.

11. The time-domain differentiator of claim 7 wherein the period is less than the wavelength divided by the product of two and the natural log of two.

12. The time-domain differentiator of claim 11 wherein the incident polarized input electromagnetic wave comprises pulses having a center frequency corresponding to the wavelength, and the grating provides a spectral operational frequency range of between about 0.3 and 1.5 times the center frequency.

13. A method for performing a time-domain differentiation of an electromagnetic pulse, comprising the steps of:
identifying an electromagnetic pulse to be differentiated, the pulse having a wavelength, a center frequency, a skin depth in a conductor, and a beam diameter;
providing a diffraction grating comprising spaced parallel conductive lines composed of the conductor, disposed on an optically transparent substrate, and having a period less than the wavelength, a thickness greater than the skin depth, an area greater than the beam diameter, and a length greater than the wavelength;
orienting the diffraction grating such that the electromagnetic pulse is incident to the diffraction grating and aligned with the conductive lines; and
capturing only the zero order diffraction of the incident electromagnetic pulse.

14. The method of claim 13 wherein the electromagnetic pulse has a frequency of greater than one terahertz.

15. The method of claim 13 wherein the conductors comprise a pattern of metal lines formed on a transparent substrate.

16. The method of claim 13 wherein the time-domain derivative is provided without using an electrical current.

17. The method of claim 13 wherein the period is less than the wavelength divided by the product of two and the natural log of two.

18. The method of claim 17 wherein the incident electromagnetic pulse comprises pulses having a center frequency corresponding to the wavelength, and the grating provides a spectral operational frequency range of between about 0.3 and 1.5 times the center frequency.
